(19) United States
(12) Patent Application Publication
(10) Pub. No.: US 2008/0148647 A1
(43) Pub. Date: Jun. 26, 2008

(54) Adjustable Mounting Assembly

(75) Inventor: Milos Pavlovic, Newmarket (CA)

Correspondence Address: MAGNA INTERNATIONAL, INC., 337 MAGNA DRIVE, AURORA, ON, L4G-7K1, omitted

(73) Assignee: MAGNA CLOSURES INC., Newmarket, ON (CA)

(21) Appl. No.: 11/573,721

(22) PCT Filed: Aug. 19, 2005
(86) PCT No.: PCT/CA05/01264

§ 371 Date: Feb. 15, 2007

Related U.S. Application Data
(60) Provisional application No. 60/602,766, filed on Aug. 19, 2004.

(51) Int. Cl. B60J 5/04

(52) U.S. Cl. 49/502

(57) ABSTRACT

A vehicle door includes inner and outer panels with a space between panels. Guide rails are mounted to the inner panel by an adjustable mounting assembly. The adjustable mounting assembly includes a first fastener, mounted to the rail, and a second fastener, mounted to the inner panel opposite the first fastener. A coupler interconnects the first and second fasteners along a common axis while providing a space between the ends of the fasteners. Apertures are provided near the bottom of the vehicle door to provide access to the couplers. Rotating the coupler with a wrench around the common axis alters the distance between the first and second fasteners.

### FIELD OF THE INVENTION

The present invention relates to window regulators for motor vehicles. More specifically, the present invention relates to a mounting assembly for a guide rail that allows for subsequent adjustments of the guide rail's position.

### BACKGROUND OF THE INVENTION

A motor vehicle door typically includes a structural body door having an outer sheet metal panel and an inner sheet metal, forming a spaced compartment therebetween. Traditionally, a plurality of door components such as a window regulator are mounted to the inner sheet metal panel. In recent years, it has become more popular to assemble hardware components onto a carrier panel that is then mounted to the inner sheet metal Trim panels are then mounted onto the dryside of the inner sheet metal to hide the unattractive hardware components.

However, after the assembled door is attached to the vehicle, it may be necessary to adjustment the position of the window regulator rails so that the glass panel raises and lowers correctly. The lower end of the rail may need to be moved away from or closer to the carrier panel so that the glass panel moves along the correct angle. This problem is especially a concern for convertible vehicles since the door lacks glass guide channels and the glass panel is typically retained only by the window regulator and the roof (when raised).

In order to facilitate these adjustments, adjustable mounting mechanism such as J-screws are typically used to mount the window regulator to either the door frame or an internal carrier panel. For example, U.S. Pat. No. 3,844,064 (hereafter the '064 patent) to Yasuma and Okada teaches the use of adjusting screws to fasten the lower end of the guide rails to the inner door panel. By adjusting the length of the adjusting screw, the distance between the guide rails and the inner door panel may be easily adjusted. However, in order to make these adjustments, access to the adjusting screw is required. Thus, if the screw heads are covered by interior trim component, the adjusting screw cannot be adjusted without removing the trim components.

This problem can be exasperated when a carrier panel is used between the inner and outer door panels. In this situation, access holes are needed in the inner door panel. For example, U.S. Pat. No. 6,425,208 to Klueger et al. (hereafter the '208 patent) teaches a door where the rails are mounted to a support panel by adjustable screws that are adjusted from the dryside of the support panel. The dryside of the support panel is subsequently covered over by a trim panel. Access holes are provided in the trim panel to provide access to the nuts so that the rails may be extended away from or towards the wetside of the carrier panel. While the vehicle door taught in the '208 patent provides improvements over the prior art, it still requires a technician to have access to the end of the adjusting screws to make adjustments to the rail.

It is therefore desirable to provide an adjusting mechanism for the guide rails that does not require access to the ends of the adjusting mechanism.

### SUMMARY OF THE INVENTION

According to a first aspect of the invention, there is provided a vehicle door. The vehicle door includes inner and outer panels with a space defined therebetween. At least one rail is mounted between the inner and outer panels by an adjustable mounting assembly. The adjustable mounting assembly is operable to adjust the distance between the at least one rail and the inner panel. At least one aperture is provided in the vehicle door in communication with the space between the inner and outer panels. The aperture provides access to the portion of the adjustable mounting assembly used to adjust the distance between the at least one rail and the inner panel.

According to a second aspect of the invention, there is provided an adjustable mounting assembly for mounting a rail to a panel. The adjustable mounting assembly includes a first fastener, operable to be mounted to the rail and a second fastener, operable to be mounted to the panel opposite the first fastener. A coupler interconnects the first and second fasteners along a common axis while providing a space therebetween. Rotating the coupler alters the distance between the first and second fasteners.

According to a third aspect of the present invention, there is provided a vehicle door including inner and outer panels with a space defined therebetween. At least one rail is mounted to the inner panel between the inner and outer panels by an adjustable mounting assembly. The adjustable mounting assembly includes a coupler located between the at least one rail and the inner panel. Manipulation of the coupler adjusts the distance between the at least one rail and the inner panel.

### BRIEF DESCRIPTION OF THE DRAWINGS

FIG. 1 is a side plan view of the wetside-facing surface of an inner panel for a vehicle door;

FIG. 2 is a side plan view of the dryside-facing surface of the inner panel shown in FIG. 1;

FIG. 3 is a fragmentary sectional view of an adjustable mounting assembly taken along lines A-A of FIG. 1; and

FIG. 4 is a fragmental sectional view of the adjustable mounting assembly taken along lines A-A of FIG. 1, showing a coupler in side-plan view.

### DETAILED DESCRIPTION OF THE INVENTION

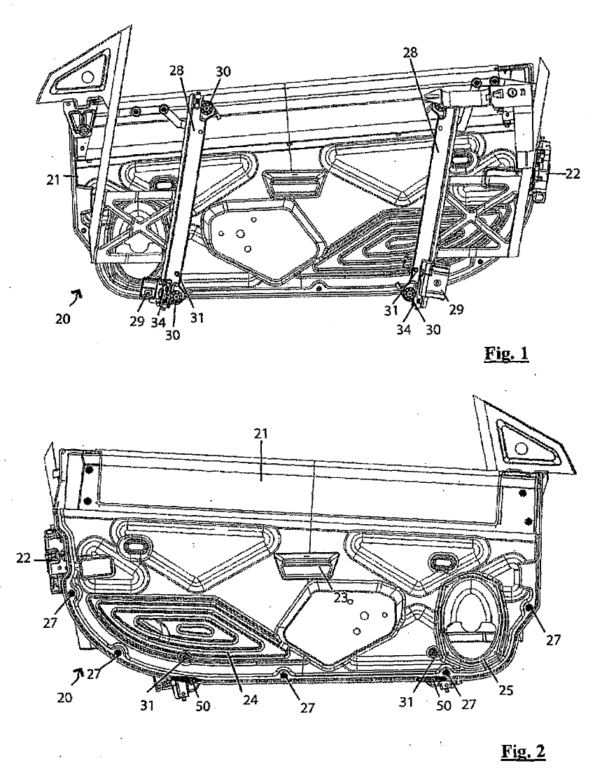

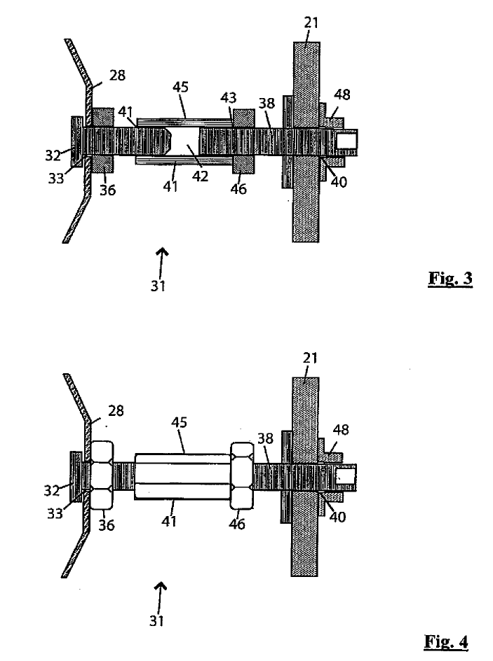

Referring now to FIGS. 1 and 2, an inner panel for a vehicle door is shown generally at 20. In the current embodiment, inner panel 20 includes a carrier plate 21 adapted to fit within a door frame (not shown) and to mount a plurality of hardware subsystems prior to insertion within the door frame. Carrier plate 21 provides opposing first and second surfaces, hereafter referred to as the “dryside” and “wetside” surfaces respectively. FIG. 2 illustrates the dryside surface of carrier plate 21, which faces the interior of the vehicle when mounted to a vehicle door frame (not shown) and is typically covered by a trim panel (also not shown). FIG. 3 illustrates the wetside surface of carrier plate 21, which faces towards the exterior sheet metal panel (not shown) of the vehicle door when mounted. Carrier plate 21 is preferably manufactured from a composite material and molded into the desired shape. In the preferred embodiment, carrier plate 21 is manufactured using a 40% polypropylene matrix with glass reinforcement fibers. Other matrix materials will occur to those of skill in the art. Other reinforcement fibers contemplated include Kevlar, carbon fibers, and hemp, and other reinforcement materials will occur to those of skill in the art.

Hardware subsystems that are typically pre-mounted to carrier plate 21 include a window regulator motor, a latch assembly 22, a handle assembly, a speaker assembly and an electrical harness assembly (other components not shown). Carrier plate 21 also includes a number of integrally formed or molded components. Integrally formed components on carrier plate 21 include an integral arm rest support 23, at least one integral energy absorption block 24, and a speaker housing 25. A plurality of fastener holes 26 spaced apart around the surface of carrier plate 21 provide a means to attach structural carrier plate 21 to the motor vehicle door body through the use of bolts, screws or the like. Preferably, a water-sealing bead 27 is formed around the perimeter of carrier plate 21 on the wetside surface. The sealing bead 27 engages the inner wall of the motor vehicle door body (not shown), providing a watertight seal for around the wetside of carrier plate 21. Water sealing bead 27 can be integrally formed from carrier plate 21 or, alternatively, water sealing bead 27 can be affixed to carrier plate 21 as a foam adhesive or the like.

A pair of guide rails 28 is mounted to the wetside surface of carrier plate 21, and a lift member 29 is slidably mounted to each of guide rails 28 and operable to move between a pair of pulleys 30. Each lift member 29 is adapted to retain a portion of a window pane (not shown). The two guide rails 28 are both mounted to carrier plate 21 by an adjustable mounting assembly 31. Adjustable mounting assemblies 31 provide for cross-car adjustment of the window pane and are operable to move their respective guide rail 28 closer to or further away from the wetside of carrier plate 21.

Referring additionally to FIGS. 3 and 4, one of the adjustable mounting assemblies 31 is described in greater detail. A fastener, such as stake stud 32 is inserted through an aperture 33 in guide rail 28 located proximate a lower end 34 of the rail, extending towards the wetside surface of carrier plate 21. The portion of stake stud 32 extending beyond guide rail 28 is threaded, and a nut 36 is located around stake stud 32 adjacent guide rail 28 to prevent stake stud 32 from slipping. A second fastener, such as jackscrew 38 extends through an aperture 40 in carrier plate 21 (FIG. 2) towards guide rail 28 so that stake stud 32 and jackscrew 38 are coaxial. The portion of jackscrew 38 extending beyond carrier plate 21 is also threaded.

A coupler 41 with an internal bore 42 and open ends 43 and 44 interconnects both stake stud 32 and jackscrew 38. Internal bore 42 provides threads complementary to the threaded portion of stake stud 32 starting at an open end 43. Starting at the other open end 44, the internal bore 42 provides threads complementary to the threaded portion of jack screw 38. Thus, the threads within internal bore 42 are split so that one half of coupler 41 proves left-handed threads and the other half provides right-handed threads. Coupler 41 is sized so that both fasteners may be securely connected within internal bore 42 with a gap existing between the two fastener ends. The exterior surface of coupler 41 is divided into six angled surfaces 45 to allow for easier rotation of coupler 41 with a wrench (not shown). A lock nut 46 is located around the threaded portion of jack screw 38 adjacent the end 43 of coupler 41 to prevent accidental movement of coupler 41 towards carrier plate 21.

During assembly of the vehicle door, the distance between guide rail 28 and carrier plate 21 can be adjusted by rotating nut 48 on J-screw 38. However, once the vehicle door is assembled, the dryside of carrier plate 21 is typically covered with a trim panel (not shown), preventing access to nut 48. If cross-car adjustments are needed post-assembly, an assembler can simply loosen lock nut 46 and rotate coupler 41 clockwise or counterclockwise without having to remove the trim over the dryside of carrier plate 21. Apertures 50 are provided in a surface of inner panel 20 below the two adjustable mounting assemblies 31. Preferably, apertures 50 are relatively long but narrow (i.e., perpendicular to adjustable mounting assemblies 31) to allow for maximum travel of a wrench. If carrier plate 21 is relatively flat, then apertures 50 can be located along the inner door frame (not shown). The assembler inserts the wrench through aperture 50 to engage the angled surfaces 45 of coupler 41. By rotating coupler 41, the distance between guide rail 28 and carrier plate 21 can be adjusted. The distance between each of the guide rails 28 and carrier plate 21 can be adjusted independently of the other, allowing for a more precise fit of the window pane. When adjustments to the coupler 41 are not being made, simple plugs can be used to cover apertures 50.

What is claimed is:

1. A vehicle door, comprising:
inner and outer panels with a space defined therebetween;
at least one rail mounted to the inner panel between the inner and outer panels by an adjustable mounting assembly, the adjustable mounting assembly operable to adjust the distance between the at least one rail and the inner panel; and
at least one aperture in the vehicle door, the aperture being in communication with the space between the inner and outer panels and providing access to a portion of the adjustable mounting assembly used to adjust the distance between the at least one rail and the inner panel.

2. The vehicle door of claim 1, wherein the adjustable mounting assembly comprises:
a first fastener, operable to be mounted to the at least one rail;
a second fastener, operable to be mounted to the inner panel opposite the first fastener.
a coupler, interconnecting the first and second fasteners while providing a space therebetween; and
whereby rotating the coupler adjusts the distance between the first and second fasteners.

3. The vehicle door of claim 2, wherein the coupler includes a first threaded end adapted to receive a threaded portion of the first fastener.

4. The vehicle door of claim 3, wherein the coupler includes a second threaded end adapted to receive a threaded portion of the second fastener and where the second threaded end on the coupler is threaded in a direction opposite to the first threaded end on the coupler.

5. The vehicle door of claim 4, wherein the coupler includes planar sides to facilitate rotation of the coupler by means of a wrench.

6. The vehicle door of claim 5, further comprising at least one locking nut located around the threaded portion of at least one of the first and second fasteners, the locking nut operable to restrict motion of the coupler around the threaded portion.

7. The vehicle door of claim 4, wherein the first fastener is a stake stud.

8. The vehicle door of claim 4, wherein the second fastener is a jack screw that includes a nut located around the threaded portion of the jack screw abutting against the surface of the inner panel on the side opposite the at least one rail.

9. The vehicle door of claim 8, further comprising at least one trim component mounted to the surface of inner panel on the side opposite the at least one rail covering over the nut of the jack screw.

10. An adjustable mounting assembly for mounting a rail to a panel, the adjustable mounting assembly comprising:
a first fastener, operable to be mounted to the rail;
a second fastener, operable to be mounted to the panel opposite the first fastener.
a coupler, interconnecting the first and second fasteners along a common axis while providing a space therebetween; and
whereby rotating the coupler alters the distance between the first and second fasteners.

11. The adjustable mounting assembly of claim 10, the coupler includes a first threaded end adapted to receive a threaded portion of the first fastener.

12. The adjustable mounting assembly of claim 11, wherein the coupler includes a second threaded end adapted to receive a threaded portion of the second fastener and where the second threaded end on the coupler is threaded in a direction opposite to the first threaded end on the coupler.

13. The adjustable mounting assembly of claim 12, wherein the coupler includes planar sides to facilitate rotation of the coupler by means of a wrench.

14. The adjustable mounting assembly of claim 12, further comprising at least one locking nut located around the threaded portion of at least one of the first and second fasteners, the locking nut operable to restrict motion of the coupler around the threaded portion.

15. The adjustable mounting assembly of claim 12, wherein the first fastener is a stake stud.

16. The adjustable mounting assembly of claim 12, wherein the second fastener is a jack screw that includes a nut located around the threaded portion of the jack screw abutting against the surface of the panel on the side opposite the at least one rail.

17. A vehicle door, comprising:
inner and outer panels with a space defined therebetween; and
at least one rail mounted to the inner panel between the inner and outer panels by an adjustable mounting assembly,
wherein the adjustable mounting assembly includes a coupler located between the at least one rail and the inner panel and that manipulation of the coupler adjusts the distance between the at least one rail and the inner panel.

18. The vehicle door of claim 17, wherein the coupler is manipulated by rotation of the coupler around its axis.

19. The vehicle door of claim 19, wherein the adjustable mounting assembly includes:
a first fastener, operable to be mounted to the at least one rail;
a second fastener, operable to be mounted to the inner panel opposite the first fastener.
a coupler, interconnecting the first and second fasteners along a common axis while providing a space therebetween; and
whereby rotating the coupler around the common axis alters the distance between the first and second fasteners.
